(19) United States
(12) Patent Application Publication
(10) Pub. No.: US 2009/0026821 A1
(43) Pub. Date: Jan. 29, 2009

(54) Motor Vehicle Seat Comprising Adjustable Lateral Cheeks

(76) Inventors: Alwin Macht, Ebensfeld (DE); Andreas Prause, Coburg (DE)

Correspondence Address: CHRISTIE, PARKER & HALE, LLP, PO BOX 7068, PASADENA, CA, 91109-7068, US

(21) Appl. No.: 11/661,711

(22) PCT Filed: Aug. 18, 2005
(86) PCT No.: PCT/DE05/01476

§ 371 Date: May 27, 2008

(30) Foreign Application Priority Data
Aug. 30, 2004 (DE) 20 2004 013 668.6

(51) Int. Cl. B60N 2/02

(52) U.S. Cl. 297/284.9

(57) ABSTRACT

A motor vehicle seat includes adjustable lateral cheeks on the seat part and/or on the backrest. The length and the orientation of the lateral cheeks in relation to the central seat area and/or backrest area can be modified by adjusting the lateral cheeks in a combined manner, especially with the aid of a combined linear and rotational guide in order to create a controlled track movement.

### CROSS-REFERENCE TO A RELATED APPLICATION

This application is a National Phase Patent Application of International Patent Application Number PCT/DE2005/001476, filed on Aug. 18, 2005, which claims priority of German Patent Application Number 20 2004 013 668.6, filed on Aug. 30, 2004.

### BACKGROUND

The invention relates to a motor vehicle seat comprising adjustable lateral cheeks on the seat part and/or on the backrest.

Anatomically shaped motor vehicle seats have raised portions on both sides of a central seat or backrest cushion surface, said raised portions, in the form of lateral cheeks, providing a seat user with improved lateral support, in particular during cornering. Lateral cheeks, which are predetermined in an unchanged manner by means of the geometry of the cushion, are optimized for the average body build of seat users, but the shape of a large number of possible seat users differs considerably from this average body build, such that, if a cross-sectional profile of the seat or of the backrest is predetermined in an unchangeable manner, slender individuals have too little lateral support, while, by contrast, individuals with a wide body build do not fit into the predetermined region between the lateral cheek contours, and they therefore partly sit on the lateral cheeks or lean against the lateral cheeks, which leads to an uncomfortable sitting position with pressure points in the region of the lateral cheeks.

In order to avoid this state, motor vehicle seats comprising adjustable lateral cheeks for the seat part and/or the backrest are known, which motor vehicle seats can be adjusted by means of a lateral cheek adjusting device from a wide position situated toward the outside of the seat into a narrow position situated toward the center of the seat.

DE 196 05 779 C2 discloses such a vehicle seat comprising adjustable seat and backrest cheeks, in which the lateral cheeks are moved by means of mechanical adjusting devices as a function of a seat user bearing pressure, which is determined by pressure sensors. For this purpose, the seat and backrest cheeks, in the form of cheek cushion parts, are held pivotably about axes running in the longitudinal direction of the seat, and therefore the seat and backrest cheeks can be pivoted with the aid of electric servomotors from a wide starting position toward the center into a narrow setting position. As an alternative to the pivotable adjustment of the seat and backrest cheeks, the seat and backrest cheeks can be arranged displaceably toward the center of the seat, or a combination of pivoting and displacing devices, such as a movement of the seat and backrest cheeks via slotted guides, is possible.

In the case of the known vehicle seat, the adjusting device comprises an electric motor which uses a spindle drive to adjust the two seat cheeks in a coupled manner toward the center of the seat until a predetermined bearing pressure on the seat user is determined by the pressure sensor. When the vehicle seat becomes free, a return again into the wide starting position takes place by activation via a seat occupancy switch.

Since, both during pivoting or linear displacement of the lateral cheeks toward the center of the seat and during a combination of pivoting and displacement, the contour or the cross-sectional profile of the lateral cheeks remains unchanged and also has a considerable curvature in the returned end position in relation to the central seat or backrest cushion, the lateral cheeks make it difficult for a passenger to get in and out.

### SUMMARY

The present invention is based on the problem of producing an ergonomically favorable adjusting movement of the lateral cheeks, of obtaining better adaptation to different anatomies of seat users and of making it easier for a seat user to occupy and leave a motor vehicle seat.

The solution according to the invention permits an ergonomically favorable adjusting movement of the lateral cheeks, better adaptation to different anatomies of seat users and makes it easier for the seat user to occupy and leave a motor vehicle seat.

By means of a combined adjusting movement of the lateral cheeks, in which the length and orientation of the lateral cheeks in relation to the central seat and/or backrest surface can be changed and, according to a further feature, can also be changed in cross-sectional profile, a controlled path movement and change of the cross-sectional profile are produced, this having the advantage that the lateral cheeks are curved forward only to a minimum extent when an individual gets into and occupies the motor vehicle seat, and therefore make it easier for the individual to get in, and subsequently, for optimum adaptation to the anatomy of the seat user, said lateral cheeks first of all execute an adjusting movement in the longitudinal direction of the seat, i.e. in the X-direction of the motor vehicle, and then pivot in the direction of the center of the seat, i.e. in the Y-direction of the motor vehicle, and therefore reduce the width of the seat. The effect achieved by this is that, if the seat user has a heavy body build, the lateral cheeks are moved out in the X-direction of the motor vehicle and only execute a slight pivoting movement if any at all, and therefore the seat user is not constricted, while, if the seat user has a slender body, the lateral cheeks are moved out in the X-direction of the motor vehicle out of the basic position and laterally support the seat user by means of a subsequent or combined pivoting movement.

Accordingly, in an advantageous refinement of the solution according to the invention, starting from a first end position in which the lateral cheeks are in a completely retracted state, the lateral cheeks are first of all predominantly extended and subsequently are predominantly pivoted about a pivot point fixed on the seat or backrest until they are in a completely extended state in an end position opposite the first end position.

The lateral cheek adjusting device preferably has a combined linear and rotational guide for producing the controlled path movement and contains a supporting bow which supports the lateral cheek cushion and is connected to a pivoting and sliding joint carrying out the controlled path movement.

In order to predetermine the combined adjusting movement of the lateral cheeks, the pivoting and sliding joint is connected to a guide slot and, in a specific embodiment, is formed in that the supporting bow can be pivoted about a pivoting bolt, which forms the pivot point fixed on the seat or backrest, and is coupled to a guide rod, which can be displaced along the guide slot and is connected to an adjusting drive, wherein the guide slot is oriented in relation to the pivoting bolt in such a manner that it neither intersects the pivoting bolt nor can be extended rectilinearly with respect to the pivoting bolt.

In this embodiment of the solution according to the invention, the adjusting movement of the lateral cheeks is controlled in such a manner that, as the guide rod approaches the pivot point, which is fixed on the backrest, or the pivoting bolt, the pivoting movement of the adjustment of the lateral cheeks is increased. The respectively desired kinematics of the adjustment operation can therefore be set by orientation of the guide slot.

Depending on the desired sequence of movement during the adjustment of the lateral cheeks, the guide slot may be of rectilinear or curved design.

The adjusting drive is preferably mounted freely and has a spindle nut which is connected to the guide rod and in which a spindle, which is connected via a worm mechanism to a driving motor, engages. Alternatively, the adjusting drive can be designed as a rack drive or can have a flexible traction means as force transmission element to the guide rod, which triggers an adjusting movement counter to the action of a resetting spring, which resets the lateral cheek adjusting device into the first end position. The separate drive of both means of adjusting the lateral cheeks of the seat part and/or of the backrest ensures independent functioning of the adjustments of the lateral cheeks, such that additional connecting elements are unnecessary. The synchronization of both means of adjusting the lateral cheeks of the seat and/or backrest part in the end stops ensure that, if required, a uniform adjustment of the lateral cheeks takes place.

### BRIEF DESCRIPTION OF THE DRAWINGS

The concept on which the invention is based will be explained in more detail with reference to an exemplary embodiment illustrated in the figures, in which:

FIG. 1 shows a perspective view of a lateral cheek adjusting device in a starting position.

FIG. 2 shows a perspective view of the lateral cheek adjusting device in a end position.

FIG. 3 shows a perspective view from the opposite side of the lateral cheek adjusting device in the end position.

FIG. 4 shows a side view of the lateral cheek adjusting device in the end position.

FIG. 5 shows a side view of the lateral cheek adjusting device in the starting position.

FIGS. 6 to 10 show schematic sectional illustrations of the various movement phases of an adjustment of the lateral cheeks with the adjusting device according to FIGS. 1 to 5.

### DETAILED DESCRIPTION

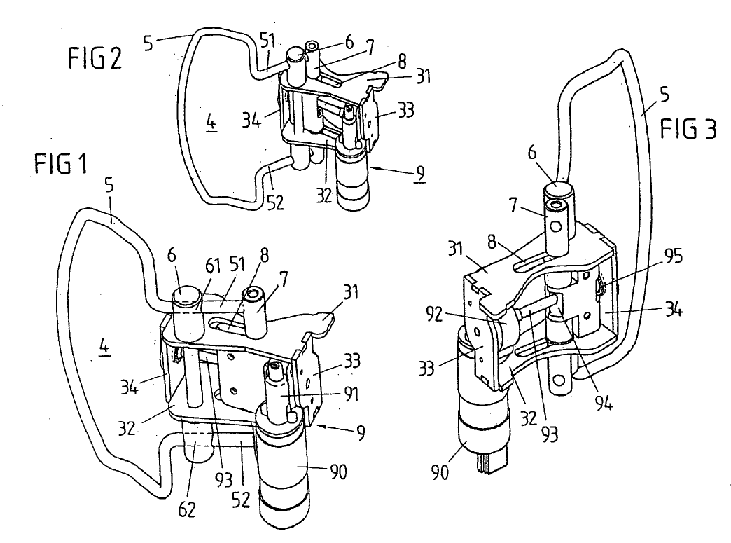

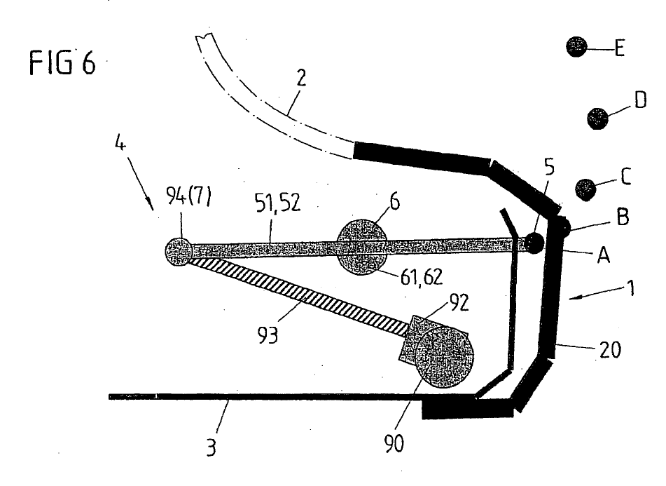

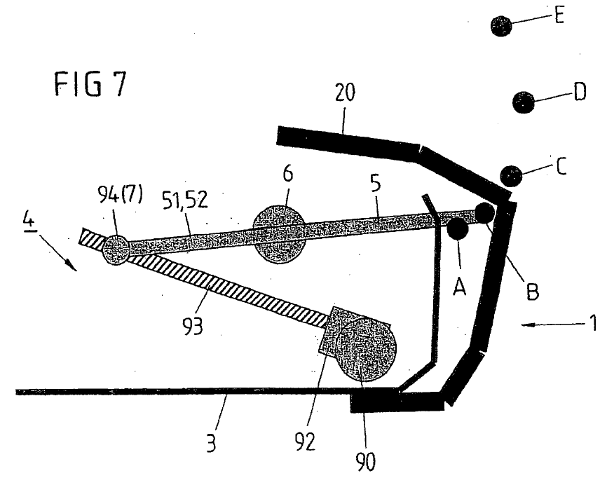

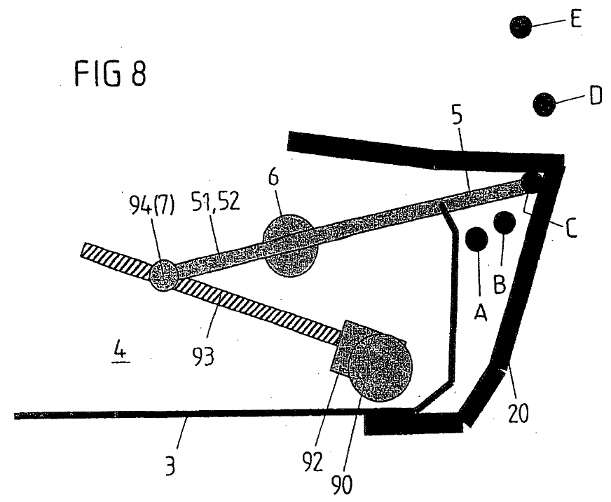

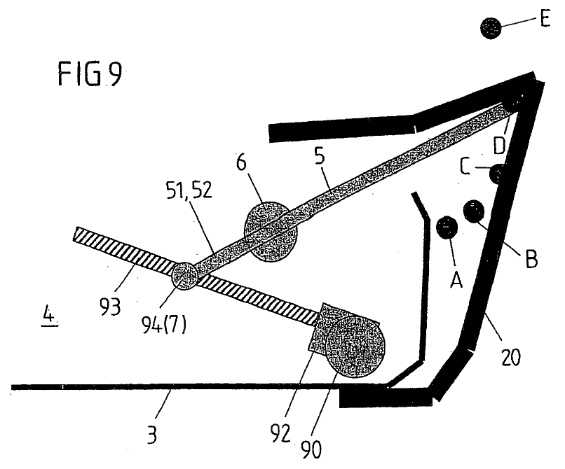

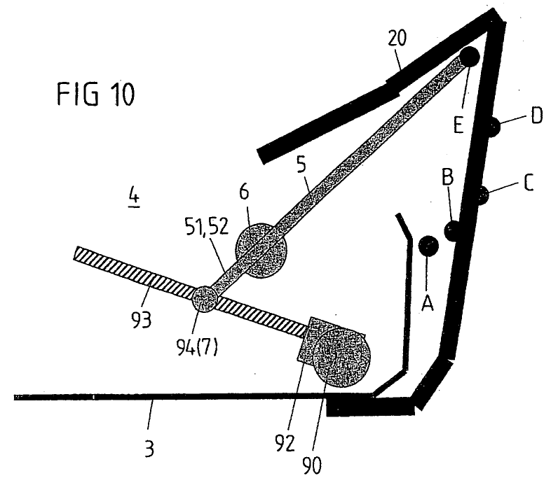

The lateral cheek adjusting device 4, which is illustrated in various perspective views and in the two end positions in FIGS. 1 to 3, contains a supporting bow 5 which, according to FIGS. 6 to 10, bears against the inside of a lateral cheek cushion 20 of a lateral cheek 1 which is adjoined by the central seat or backrest cushion 2 of a motor vehicle seat. The supporting bow 5 has push rods 51, 52 which run parallel to each other, are inserted through guide holes 61, 62 of a pivoting bolt 6, which forms a pivot point fixed on the seat or backrest, and can be displaced longitudinally within the guide holes 61, 62. The ends of the push rods 51, 52 are connected to a guide rod 7 which runs essentially parallel to the pivoting bolt 6 and is mounted in a guide slot 8.

In the exemplary embodiment illustrated in FIGS. 1 to 5, the guide slots 8, which are provided in the form of a recess in the side plates 31, 32 of a housing, are of rectilinear design and are oriented in such a manner that the pivoting bolt 6, and therefore the pivot point fixed on the seat or backrest, neither intersects the guide slot 8 nor is situated in the extension thereof. Since an angle is enclosed between the orientation of the guide slot 8 and the push rods 51, 52, which produce the connection between the guide rod 7 and the pivoting bolt 6, during an adjustment of the guide rod 7 a pivoting and pushing movement of the supporting bow 5 is caused, the course of which movement is explained in more detail below with reference to FIGS. 6 to 10.

In the embodiment, illustrated in FIGS. 1 to 5, of a lateral cheek adjusting device 4, a spindle drive with a driving motor 90 and a driving worm 91, which is connected to the motor shaft and meshes with a worm wheel 92, which is connected in a rotationally fixed manner to a spindle 93, serves as the adjusting drive 9. The spindle 93 engages in a fixed spindle nut 94 which is connected to the guide rod 7. The spindle 93 is supported on a bearing 95 of a bearing plate 34 of the housing 3, which bearing plate connects the side plates 31, 32. A base plate 33 of the housing serves to keep the side plates 31, 32 apart and to stabilize the housing.

FIG. 1 shows, in a perspective illustration, and FIG. 5, in a side view, the lateral cheek adjusting device 4 in a first end position or starting position of the adjustment of the lateral cheeks, in which the supporting bow 5 is completely lowered.

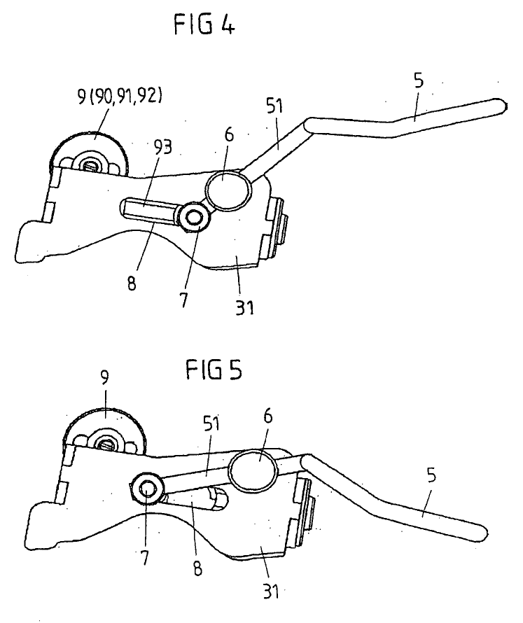

FIG. 2 shows, in the same perspective illustration as FIG. 1, FIG. 3, in a perspective view from the opposite side, and FIG. 4, in a side view, the lateral cheek adjusting device 4 in the end position which is opposite the first end position and in which the supporting bow 5 is completely raised, i.e. is pivoted to the maximum and adjusted linearly.

The individual phases of the adjusting movement of the lateral cheeks, starting from the first end position illustrated in FIGS. 1 and 5 to the opposite end position, illustrated in FIGS. 2 to 4, are explained in more detail below with reference to the schematic cross-sectional illustrations in FIGS. 6 to 10.

In order to clarify the different possibilities of realizing the adjusting kinematics, in the schematic side views of FIGS. 6 to 10 the adjusting drive 9 is situated on the side of the supporting bow 5 in relation to the pivot point, which is fixed on the seat or backrest and is in the form of the pivoting bolt 6, such that, during an adjusting movement, starting from the first end position with the supporting bow 5 completely lowered, the guide rod 7 is brought up to the adjusting drive 9 while, in the illustrations according to FIGS. 1 to 5, it is moved away by the adjusting drive 9 from the first end position into the opposite end position during a combined pivoting and pushing movement.

FIG. 6 shows the lateral cheek adjusting device 4 in the first end position, which is illustrated in FIGS. 1 to 5 and in which the cross strut of the supporting bow 5 is in the completely lowered position A.

For better understanding of the adjusting kinematics, the positions A, B, C, D and E taken up by the supporting bow 5 in the individual adjusting phases of the lateral cheek adjusting device 4 are plotted in FIG. 6 and the following FIGS. 7 to 10.

The lateral cheek adjusting device 4 is arranged within a seat or backrest frame 3 and shows the orientation of the push rods 51, 52, which are guided in the guide holes 21, 22 of the pivoting bolt 6, in the position of the spindle nut 94 or of the guide rod 7 receiving the push rods 51, 52 in which it is at the greatest distance away from the worm wheel 92 or the driving motor 90. As a consequence of the fixed spindle nut 94, rotation of the spindle 93 causes the guide rod 7 to move in the direction of the driving device 9, such that, as a consequence of the pivot point, which is provided by the pivoting bolt 6 and is fixed on the seat or backrest, the push rods 51, 52 are displaced in the direction of the pivoting bolt 6 and, accordingly, the supporting bow 5 is displaced essentially linearly.

By the guide rod 7 being brought up to the pivoting bolt 6 during a rotation of the spindle 93, the supporting bow 5 is therefore moved, according to FIG. 7, into the position B, this first phase of the movement predominantly comprising a linear movement, since the preceding first end position or starting position A essentially still coincides with the orientation of the supporting bow 5.

Upon further rotation of the spindle 93 and therefore approach of the guide rod 7 to the pivoting bolt 5, the push rod 51, 52 is displaced further in the direction of the pivoting bolt 6, but also, as a consequence of the guide rod 7 approaching further toward the pivoting bolt 6, an increased pivoting movement is carried out at the same time, in which the supporting bow 5 reaches the position C. A comparison of position C with the preceding positions A and B shows the greater pivoting movement of the supporting bow 5 in comparison to a linear adjustment.

As the guide rod 7 approaches the pivoting bolt 5 during further rotation of the spindle 93, the pivoting movement of the supporting bow 5 increases in comparison to the linear adjustment of the push rods 51, 52, such that the lateral cheek cushion 20 of the lateral cheek 1 is moved to an increased extent toward the center of the seat. A comparison of the orientation of the supporting bow 5, which orientation is illustrated schematically in FIG. 9 and in which the supporting bow has reached the position D, with the preceding position C clarifies the further increase in the pivoting movement.

Finally, upon further rotation of the spindle 93, the supporting bow 5 reaches the end position E which is opposite the first end position A, and therefore the closest approach of the guide rod 7 to the pivoting bolt 6, with the distance between the individual positions A, B, C, D, E each clarifying the increased pivoting movement of the lateral cheek adjusting device 4 in comparison to a linear movement.

Although, in the case of the exemplary embodiments illustrated in the drawing and described above, the lateral cheek adjusting device 4 is operated with a spindle drive 9 as the adjusting drive, other adjusting drives, such as, for example, rack drives or cable drives, can in principle also be used. If a cable drive is used, because force is only transmitted on one side, an additional resetting spring or deflection has to be provided in a manner known per se.

The realization of the lateral cheek adjusting device is also not restricted to a rectilinear slotted guide 8 but can also be realized by a curved slotted guide with a continuous profile or can be realized discontinuously, for example in the form of individual, rectilinear sections at an angle to one another.

1-18. (canceled)

19. A motor vehicle seat comprising:
adjustable lateral cheeks on at least one of a seat part and on a backrest; and
wherein the lateral cheeks are adjustable in a combination of length and orientation relative to at least one of a central seat surface and a backrest surface.

20. The motor vehicle seat of claim 19, wherein a cross-sectional profile of the lateral cheeks is adjustable.

21. The motor vehicle seat of claim 19 or 20, wherein, starting from a first end position in which the lateral cheeks are in a completely retracted state, the lateral cheeks are first predominantly extended and subsequently are predominantly pivoted about a pivot point fixed on the seat or backrest until the lateral cheeks are in a completely extended state in an end position opposite the first end position.

22. The motor vehicle seat of claim 19, further comprising a lateral cheek adjusting device with a combined linear and rotational guide for producing a controlled path movement.

23. The motor vehicle seat of claim 22, wherein the lateral cheek adjusting device has a supporting bow supporting a lateral cheek cushion and connected to a pivoting and sliding joint carrying out the controlled path movement.

24. The motor vehicle seat of claim 23, wherein the pivoting and sliding joint contains a guide slot having a shape, length and orientation in relation to the pivot point fixed on the seat or backrest to determine the adjusting movement of the lateral cheeks.

25. The motor vehicle seat of claim 23 or 24, wherein the supporting bow is pivotable about a pivoting bolt forming the pivot point fixed on the seat or backrest, and wherein the supporting bow is coupled to a guide rod displaceable along the guide slot and connected to an adjusting drive.

26. The motor vehicle seat of claim 23 or 24, wherein the guide slot is oriented in relation to the pivoting bolt in such a manner that the guide slot neither intersects the pivoting bolt nor is extendable can be extended rectilinearly with respect to the pivoting bolt.

27. The motor vehicle seat of claim 24, wherein the guide slot is rectilinear.

28. The motor vehicle seat of claim 24, wherein the guide slot is curved.

29. The motor vehicle seat of claim 25, wherein the supporting bow comprises push rods having ends inserted through guide holes in the pivoting bolt and connected to the guide rod guided in the guide slot.

30. The motor vehicle seat of claim 25, wherein the adjusting drive is mounted freely.

31. The motor vehicle seat of claim 25, wherein the adjusting drive has a spindle nut connected to the guide rod and in which a spindle connected via a worm mechanism to a driving motor, engages.

32. The motor vehicle seat of claim 25, wherein the pivoting bolt is inserted through mutually aligned holes of two spaced-apart housing plates in which the guide slot is arranged, the guide slot configured as a cutout.

33. The motor vehicle seat of claim 25, wherein the adjusting drive is designed as a rack drive.

34. The motor vehicle seat of claim 25, wherein the adjusting drive has a flexible traction device configured as force transmission element to the guide rod, wherein the force transmission element triggers an adjusting movement counter to the action of a resetting spring configured to reset the lateral cheek adjusting device into a first end position.

35. The motor vehicle seat of claim 19, wherein each lateral cheek comprises a lateral cheek adjusting device, and wherein the lateral cheek adjusting devices of both lateral cheeks are driven separately from each other.

36. The motor vehicle seat of claim 19, wherein each lateral cheek comprises a lateral cheek adjusting device having a driving motor, and wherein the driving motors of the lateral cheek adjusting devices can be synchronized in end stops of the lateral cheeks.
